(19) United States
(12) Patent Application Publication
(10) Pub. No.: US 2026/0199767 A1
(43) Pub. Date: Jul. 16, 2026

(54) SYSTEM FOR PROVIDING PUTTING INFORMATION, METHOD FOR PROVIDING PUTTING INFORMATION AND METHOD FOR CONTROLLING USER TERMINAL

(71) Applicant: GOLFZON CO., LTD., Seoul (KR)

(72) Inventors: Jae Yoon OK, Goyang-si Gyeonggi-do (KR); Hyung Wook JANG, Sejong-si (KR)

(73) Assignee: GOLFZON CO., LTD., Seoul (KR)

(21) Appl. No.: 18/867,799

(22) PCT Filed: May 23, 2023
(86) PCT No.: PCT/KR2023/006965

§ 371 Date: Nov. 20, 2024

(30) Foreign Application Priority Data
May 25, 2022 (KR) 10-2022-0064150

(51) Int. Cl. A63B 71/06; A63B 69/36; A63B 102/32

(52) U.S. Cl. CPC A63B 71/0622; A63B 69/3658; A63B 69/3676; A63B 2102/32; A63B 2220/12; A63B 2220/18; A63B 2220/20

(57) ABSTRACT

The present invention provides a system for providing putting information, method for providing putting information, method for controlling user terminal for guiding user's putting play and recording media recording the method readable by computing device, when a user accesses a server with a user terminal possessed by the user who plays golf on a golf course and putts on a green of the golf course, the user can receive information on the green being putted and an accurate putting guide based on topography of the green between a golf ball and a hole-cup on the green from the server through the user terminal using information obtained using a putting interface displayed on the user terminal so that the user who putts on the green to easily perform putting play without help of a caddy or the like.

### TECHNICAL FIELD

The present invention is related to, a system for providing putting information, method for providing putting information, method for controlling user terminal for guiding user's putting play and recording media recording the method readable by computing device, that can provide information for guiding a user's golf play, especially putting play, through a user terminal such as a mobile terminal or a golf-only terminal possessed by a user who plays golf on a golf course.

### BACKGROUND ART

In general, golf is a sport that records the number of golf shots taken while playing in 18 or more holes, and the smaller the number of shots, the better the record.

Golfers use a variety of methods to reduce the number of shots of golf recorded when playing golf on a golf course. Golfers often receive information on the topographical characteristics of a golf course and information on an appropriate targeting method at each hole of the golf course through a mobile terminal and use it to establish their own golf round operation strategy.

A conventional terminal for providing golf information stores topographic information of a golf course and uses GPS position information to identify the user's current position information to provide remaining distance information from the current position to a position of a hole-cup, or stores standardized information about golf strategies at the golf course and then provides it to the user.

However, since the conventional terminal for providing golf information simply provides standardized information about the topography of the golf course through a two-dimensional map, the information provided to users who play golf is inevitably limited. Therefore, the conventional terminal for providing golf information has limitations in providing useful information that can directly help users in the user's current situation.

In particular, when a user putts a golf ball on the green, the putting on the green is one of the most difficult parts of golf play because a hole-in is possible only when the user accurately grasps the topography of the green and putts the golf ball in an appropriate intensity and direction. Since it is very difficult to play such a good putting play, the most necessary information for the user playing a golf round is information that may be helpful when putting.

As described above, a number of prior arts related to providing putting information that may be helpful for the user's putting play through the user's mobile terminal have been disclosed.

For example, prior art documents such as Korean Patent Publication No. 10-2011-0107601, Korean Patent Publication No. 10-2019-0034045 and Korean Patent Publication No. 10-2012-0131037 are disclosed.

According to the prior arts as described above, a user can take a picture of a golf ball and a hole-cup placed on the green with a terminal, and the terminal can calculate the position information of the golf ball using the result of analyzing the picture and GPS position information. However, since it is difficult to obtain accurate results in this way, there is a disadvantage that putting-related information provided to the user may become meaningless.

In addition, there was a problem that the entire system and control process were complicated because additional equipment or analysis means were needed to accurately grasp the green lie between the golf ball and the hole-cup on the green and provide accurate putting information to users based on the green lie.

Prior Art Documents related to the present invention are as follows:
Korean Patent Publication No. 10-2011-0107601
Korean Patent Publication No. 10-2019-0034045
Korean Patent Publication No. 10-2012-0131037

### DISCLOSURE

### Technical Problem

It is an object of the present invention to provide a system for providing putting information, method for providing putting information, method for controlling user terminal for guiding user's putting play and recording media recording the method readable by computing device, when a user accesses a server with a user terminal possessed by the user who plays golf on a golf course and putts on a green of the golf course, the user can receive information on the green being putted and an accurate putting guide based on topography of the green between a golf ball and a hole-cup on the green from the server through the user terminal using information obtained using a putting interface displayed on the user terminal so that the user who putts on the green to easily perform putting play without help of a caddy or the like.

### Technical Solution

In accordance with an aspect of the present invention, the above and other objects can be accomplished by the provision of a method for providing putting information to a user who play golf on a golf course to guide putting play through a user terminal by a server, the method comprising: transmitting green terrain information about a real green where the user plays putting to the user terminal connected to the server; determining a ball position on a virtual green which is generated based on the green terrain information corresponding to a position of a golf ball on the real green, and generating putting information including a distance between the golf ball and a hole-cup on the real green and a green lie using the determined ball position and a cup position on the virtual green corresponding to a position of the hole-cup on the real green by the user's manipulation through a putting interface of the user terminal for processing to generate the putting information; and generating putting guide information including at least one of a putting expected path and a putting direction from the ball position to the cup position on the virtual green using the generated putting information so that the putting guide information is provided through the putting interface.

The generating putting information includes: receiving a position of the user terminal by a GPS module of the user terminal as the user manipulates through the putting interface at a location adjacent to the golf ball placed on the real green; and determining the received position of the user terminal as the ball position on the virtual green, generating information on the distance and slope from the ball position to the cup position as the putting information.

The putting interface is configured to capture and display the golf ball and the hole-cup on the real green by a camera of the user terminal, and to display a ball position alignment portion so that the captured golf ball can be aligned at a predetermined position on the putting interface, and the generating putting information includes: determining the ball position on the virtual green using a position of the user terminal by a GPS module of the user terminal, a cup position on the virtual green, and a positional relationship between the golf ball and the hole-cup aligned through the putting interface as the user aligns the golf ball with the hole-cup on the putting interface; and generating information on the distance and slope from the ball position to the cup position as the putting information.

The generating putting guide information so that the putting guide information is provided through the putting interface includes: determining a putting direction starting from the ball position based on the green lie between the ball position and the cup position on the virtual green; and determining a path from the ball position to the cup position formed by the green lie if the golf ball is putted from the ball position to the putting direction as a putting expected path.

The method for providing putting information to the user may further comprises: determining a putting aiming point in the determined putting direction; and determining a directional distance, which is a distance from the cup position to the putting aiming point.

An embodiment of the present invention may comprise a recording media readable by computing device recording the above stated method.

In accordance with another aspect of the present invention, there is provided a method for controlling a user terminal for guiding a user who play golf on a golf course to putt on a real green, the method comprising: downloading green terrain information about the real green from a server connected to the user terminal; displaying a putting interface for generating putting information including a distance between a golf ball and a hole-cup on the real green and a green lie; when a ball position on a virtual green which is generated based on the green terrain information corresponding to a position of a golf ball on the real green by the user's manipulation through a putting interface of the user terminal is determined, displaying putting information generated using the determined ball position and a cup position on the virtual green corresponding to a position of the hole-cup on the real green; and displaying on the putting interface, putting guide information including at least one of a putting expected path and a putting direction from the ball position to the cup position on the virtual green determined using the generated putting information.

The displaying putting information includes: detecting the user's manipulation through the putting interface and determining a position of the user terminal by a GPS module of the user terminal as the ball position on the virtual green; and displaying the determined result of the distance and slope from the determined ball position to the cup position on the putting interface.

The putting interface is configured to capture and display the golf ball and the hole-cup on the real green by a camera of the user terminal, and to display a ball position alignment portion so that the captured golf ball can be aligned at a predetermined position on the putting interface, and the displaying putting guide information includes: determining the ball position on the virtual green using a position of the user terminal by a GPS module of the user terminal, a cup position on the virtual green, and a positional relationship between the golf ball and the hole-cup aligned through the putting interface as the user aligns the golf ball with the hole-cup on the putting interface; and displaying on the putting interface, the distance and slope from the ball position to the cup position.

The displaying putting guide information includes: when a putting direction starting from the ball position based on the green lie between the ball position and the cup position on the virtual green is determined, displaying a line of the putting direction, which is a straight line from the ball position to a putting aiming point in the putting direction, on the putting interface as the putting guide.

The displaying putting guide information includes: when a putting direction starting from the ball position based on the green lie between the ball position and the cup position on the virtual green is determined, displaying a putting line of a path from the ball position to the cup position formed by the green lie if the golf ball is putted from the ball position to the putting direction, on the putting interface as the putting guide.

The displaying putting guide information further includes: when a putting direction starting from the ball position based on the green lie between the ball position and the cup position on the virtual green is determined, and a putting aiming point on the putting direction from the ball position is determined, displaying a directional distance, which is a distance from the cup position to the putting aiming point, on the putting interface.

An embodiment of the present invention may comprise a recording media readable by computing device recording the above stated method for controlling the user terminal.

In accordance with another aspect of the present invention, there is provided a system for providing putting information to a user who play golf on a golf course to guide putting play through a user terminal, the system comprising: a database that stores green terrain information about a green of each hole in the golf course; and a server that communicates with the user terminal through network connection, wherein the server extracts green terrain information about the green of the hole in which the user is playing from the database and transmits the extracted information to the user terminal, and wherein the server generates putting information for guiding the user's putting play based on a virtual green generated by the extracted green terrain information and provides the generated information to the user through the user terminal, wherein the server is configured to process: determining a ball position on a virtual green which is generated based on the green terrain information corresponding to a position of a golf ball on the green on which the user is playing by the user's manipulation through a putting interface of the user terminal for processing to generate the putting information including a distance between the golf ball and a hole-cup on the real green and a green lie; generating the putting information using the determined ball position and a cup position on the virtual green corresponding to a position of a hole-cup on the green; and generating putting guide information including at least one of a putting expected path and a putting direction from the ball position to the cup position on the virtual green using the generated putting information so that the putting guide information is provided through the putting interface.

### Advantageous Effects

A system for providing putting information, method for providing putting information, method for controlling user terminal for guiding user's putting play and recording media recording the method readable by computing device according to the present invention have an advantageous effect that when a user accesses a server with a user terminal possessed by the user who plays golf on a golf course and putts on a green of the golf course, the user can receive information on the green being putted and an accurate putting guide based on topography of the green between a golf ball and a hole-cup on the green from the server through the user terminal using information obtained using a putting interface displayed on the user terminal so that the user who putts on the green to easily perform putting play without help of a caddy or the like.

### DESCRIPTION OF DRAWING

FIG. 1 is a block diagram showing a configuration of a system for providing putting information according to an embodiment of the present invention.

FIG. 2 is a flowchart showing a process of a method for providing putting information or a method of controlling a user terminal according to an embodiment of the present invention.

FIG. 3 shows a view (A) of a display screen of the user terminal on which hole information required at a tee shot position of a hole currently being played by the user is shown, a view (B) of the display screen of the user terminal on which hole information required at a second shot position is shown, and a view (C) of the display screen of the user terminal on which hole information required at an approach shot position is shown.

FIG. 4 shows a situation in which a position of a golf ball is specified on the green in the golf round of the user according to an embodiment of the present invention.

FIG. 5 shows a process in which the user specifies a position of the golf ball through the putting interface of the user terminal in a state shown in FIG. 4 and putting information based on the position is displayed on the putting interface.

FIG. 6 shows a state in which a putting guide is displayed through the putting interface of the user terminal in the state shown in FIG. 5.

FIG. 7 shows another situation in which the position of the golf ball on the green is specified in the golf round of the user according to an embodiment of the present invention.

FIGS. 8 to 10 show a process in which the user specifies a position of the golf ball through the putting interface of the user terminal in a state shown in FIG. 7.

FIG. 11 shows a state in which the putting guide is displayed through the putting interface of the user terminal in the state shown in FIG. 7.

### BEST MODEL

A system for providing putting information, method for providing putting information, method for controlling user terminal for guiding user's putting play and recording media recording the method readable by computing device according to the present invention will be described in detail with reference to the accompanying drawings.

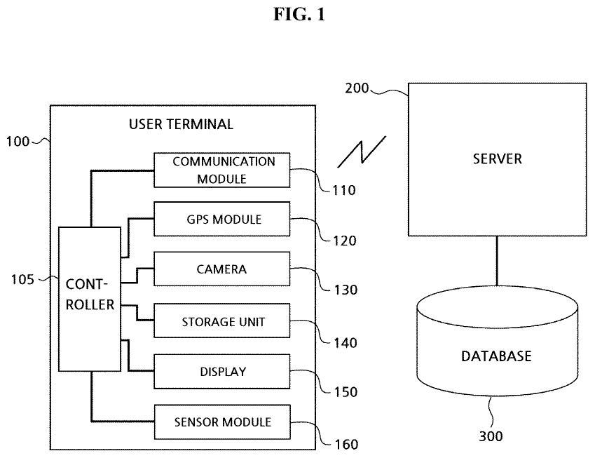

First, a system for providing putting information according to an embodiment of the present invention will be described with reference to FIG. 1. FIG. 1 is a block diagram showing a configuration of a system for providing putting information according to an embodiment of the present invention.

The system for providing putting information according to an embodiment of the present invention may be configured that each user terminal 100 possessed by each of the plurality of users playing golf on a golf course may be communicatively connected to a server 200 to provide golf information, especially putting information on a green, to each corresponding user through data communication with the server 200.

The user terminal 100 may include a personal portable communication terminal such as a smartphone or a tablet PC, and may also include a golf terminal for providing golf information used in a golf course.

The user terminal 100 of the system for providing putting information according to an embodiment of the present invention may include a controller 105, a communication module 110, a GPS module 120, a camera 130, a data storage unit 140, a display 150, a sensor module 160, and the like.

The user terminal 100 as described above may have a configuration basically possessed by a conventional smartphone or a personal portable terminal, and such a configuration may be a known configuration or a known configuration.

The communication module 110 allows the user terminal 100 to perform data communication with the server 200, such as wireless communication, i.e. WiFi, and the controller 105 may receive position information by the GPS module 120 and transmit it to the server 200 through the communication module 110 as position information of the user terminal.

The server 200 may calculate the position information of the golf ball using the position information of the user terminal, and may provide various putting information based on the position information of the golf ball.

The user terminal 100 may capture a hole-cup and a golf ball on the green on the screen using the camera 130, the position of the golf ball may be calculated using the captured information, and the server may provide various putting information based on the position of the golf ball.

The data storage unit 140 of the user terminal 100 may store various data such as topographic information of each hole of the golf course received from the server 200, especially topographic information on the green of each hole, various data for image processing topographic information including each hole and green in the form of a map, and data for implementing various putting information to be provided to the user.

The display 150 outputs putting information to be provided to the user on the screen, and may be configured as a touch panel so that the user may input information through a touch gesture.

The sensor module 160 is a module capable of sensing the operation and posture of the terminal, including an acceleration sensor, a gyro sensor, and may be used to calculate the position of the golf ball.

The controller 105 is an element that performs various operations or information processing necessary by various programs or applications running on the user terminal. In the system for providing putting information according to the present invention, the controller 105 of the user terminal may control elements including the data storage unit 140, the display 150, the camera 130, the GPS module 120, and the sensor module 160 by a predetermined program or application, or receive necessary information from each element to generate putting information to be finally provided to the user while performing necessary operations or information processing.

The system for providing putting information according to an embodiment of the present invention includes a database 300 for storing topographic information (including green topographic information on the green of each hole) for each hole of the golf course, and a server 200, as shown in FIG. 1. The server communicates with the user terminal through the connected network, extracts green terrain information on the green of the hole that the user is playing from the database 300 and transmits it to the user terminal 100. Also, the server may generate and provide putting information for guiding the user's putting play based on a virtual green by the extracted green terrain information.

The server 200 may determine a ball position on the virtual green corresponding to the position of the golf ball on the green(real green) by the user's manipulation through the putting interface for calculating putting information including the distance between the golf ball and the hole-cup and the green lie on the green that the user is playing. The server may calculate the putting information using the determined ball position and a cup position on the virtual green corresponding to the hole-cup position on the real green.

In addition, the server 200 may calculate putting guide information including at least one of a putting expected path from the ball position to the cup position and a putting direction on the virtual green using the above putting information such as the distance between the golf ball and the hole-cup and the green lie, so that the calculated putting guide information can be provided through the putting interface on the user terminal.

More detailed descriptions on providing the putting guide information through the putting interface as described above will be described below.

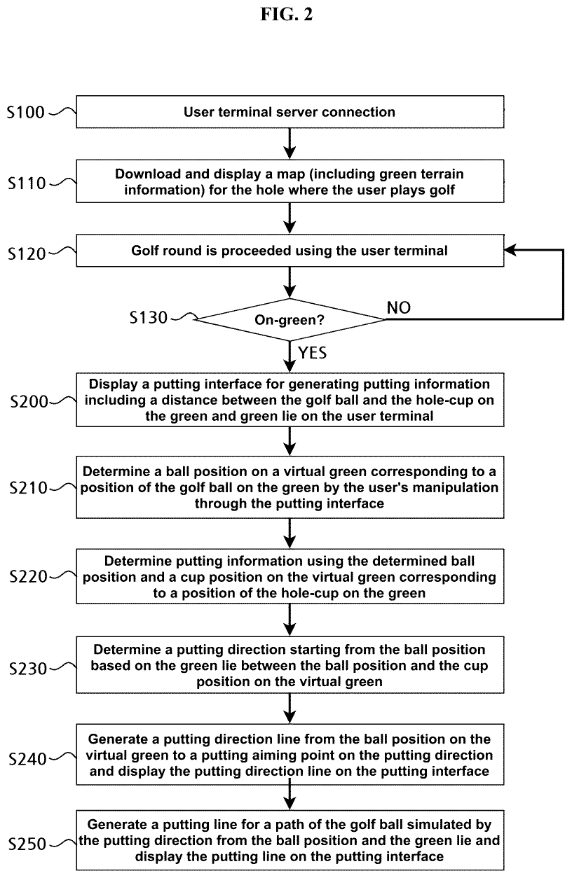

Meanwhile, referring to FIGS. 2 to 10, a method for providing putting information using the system for providing putting information or a method of controlling the user terminal for guiding the user's putting play according to an embodiment of the present invention will be described.

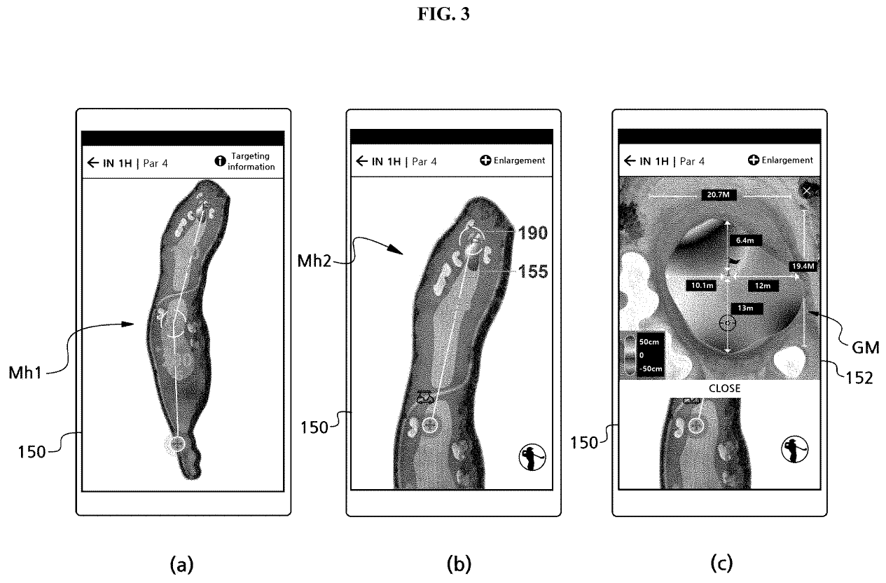

FIG. 2 is a flowchart showing a process of the method for providing putting information or the method of controlling the user terminal according to an embodiment of the present invention, and FIGS. 3 to 10 show exemplary drawings for explaining each step of the flowchart shown in FIG. 2 in more detail, and hereinafter, the flowchart shown in FIG. 2 will be described with reference to exemplary drawings of FIGS. 3 to 10.

As shown in FIG. 2, each of the users who play golf on a golf course may access the server through his/her user terminal (S100), and each user terminal may download map information (including green terrain information) for the corresponding hole in which the user plays golf from the server and display it on the display screen (S110).

Each user who plays golf can play using golf information, e.g., various information necessary to proceed with the golf round, such as shape and composition of the currently played hole, locations of the features in the hole, distance to a hole-cup, hole targeting information, expected progress path, distance to each point on the path, etc. provided through the user terminal (S120).

FIG. 3 shows an example of information on the hole provided through the user terminal as described above and information on the green of the hole.

FIG. 3(a) is a view of a display screen of the user terminal on which hole information required at a tee shot position of a hole currently being played by the user is shown, FIG. 3(b) is a view of the display screen of the user terminal on which hole information required at a second shot position is shown, and FIG. 3(c) is a view of the display screen of the user terminal on which hole information required at an approach shot position is shown.

When a user enters a specific hole and takes a tee shot or before, the user terminal may download map information for the hole from the server and display the entire map Mh1 on the display 150 as shown in FIG. 3(a), thereby providing information that allows the user to establish of what strategy to play golf on the hole at the tee shot location.

When taking a second shot after taking the tee shot, as shown in FIG. 3(b), the user terminal may recognize a position of the second shot or a position of the user and display an intermediate map Mh2 to enlarge the area from the position of the second shot or the user's position to the green to provide information that allows the user to establish what kind of target strategy to proceed from the second shot position.

As shown in FIG. 3(c), from the position where the user can take an approach shot or from the second shot position, the user terminal may display a green map GM displayed by enlarging the green by the user's selection on a separate window 152.

As described above, the server and the user terminal recognize the location of the user terminal or the location of the golf ball and provide detailed information about the hole currently being played step by step so that the user can play golf well in the hole.

Returning to FIG. 2 again, when the user's golf ball is seated on the green in the process as described above, that is, when the user's golf ball is on-green (S130), the server and the user terminal may detect the position of the user terminal or the position of the golf ball to recognize that the golf ball is on-green, and accordingly, information for the user to putt may be provided.

That is, when the server recognizes that the golf ball of the user is on-green, the user terminal may display a putting interface on the display screen (S200). Wherein “the putting interface” is a screen image displayed on the display of the user terminal to calculate and provide ‘putting information’ including information such as a distance between the golf ball and the hole-cup on the real green, and a green lie.

In a state in which the putting interface is displayed on the user terminal, the server may determine a ball position on a virtual green corresponding to the position of the golf ball on the real green by the user's manipulation through the putting interface displayed on the user terminal (S210).

Wherein “the virtual green” is a green that is virtually generated by the server according to the terrain information of the real green in order to provide the putting information through the user terminal. That is, the virtual green is geographic information generated in a virtual space and has the same topography information of the real green.

Since the server already has information on the hole-cup position on the real green of the hole, a cup position on the virtual green corresponding to the hole-cup position on the real green is also already known.

The server may calculate putting information, that is, the distance between the golf ball and the hole-cup on the real green, and the green lie (topography-related information such as the slope or undulations of terrain between the golf ball and the hole-cup) using the ball position and the cup position on the virtual green (the ball position and the cup position on the virtual green are equally corresponding to the golf ball position and the hole-cup position on the real green, respectively) (S220).

In addition, the server may determine the putting direction starting from the ball position on the virtual green based on the green lie between the ball position and the cup position on the virtual green corresponding to the real green (S230).

That is, it is possible to calculate the putting direction that allows the golf ball to reach the hole-cup position according to the green lie between the ball position and the cup position on the virtual green when hitting the golf ball at the ball position.

The user terminal may generate a line of the putting direction from the ball position on the virtual green to a putting aiming point in the putting direction. The user terminal may guide the putting to the user by displaying the generated putting direction line at the object corresponding to the golf ball displayed on the putting interface (S240).

In addition, the server may generate a putting line forming a path of a ball object to be simulated from the ball position on the virtual green based on the green terrain between the ball position and the cup position as described above. The server may guide the user to make a putting considering the green terrain by displaying the putting line from the ball object to the hole-cup object on the putting interface. The putting interface may display both the putting direction line and the putting line progressing from the ball position on the virtual green (S250).

As described above, the server generates the virtual green based on actual green topography information and performs determining the ball position on the virtual green in the step of S210, calculating the putting information in the step of S220, determining the putting direction in the step of S230, generating the putting direction line in the step of S240, and generating the putting line in the step of S250, using the ball position and cup position on the generated virtual green. Wherein the server may transmit the information generated as described above to the user terminal so as to be displayed on the putting interface of the user terminal. Alternatively, the server may transmit basic green topography information to the user terminal, and the user terminal may perform operations and calculations in each step of S210 to S250 described above and display the result on the putting interface.

As described above, in FIG. 2, the putting direction from the ball position to the cup position is determined using the ball position and the cup position on the virtual green, and then the putting line from the ball position to the cup position is generated based on the determined putting direction. However, the present invention is not limited to this, and it is also possible to first calculate the putting line calculated by simulating the movement path of the ball object from the ball position to the cup position on the virtual green, and to generate the putting direction line by determining the putting direction starting from the ball position based on the calculated putting line.

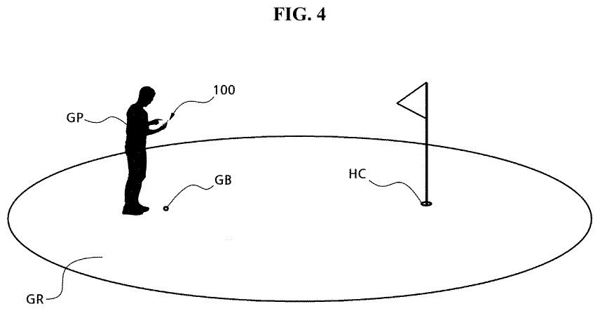

Hereinafter, processes according to steps S200 to S250 described above will be described with reference to the drawings shown in FIGS. 4 to 10, respectively.

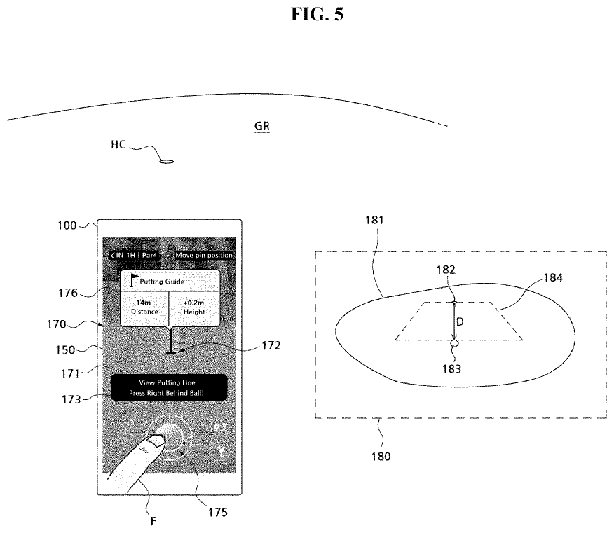

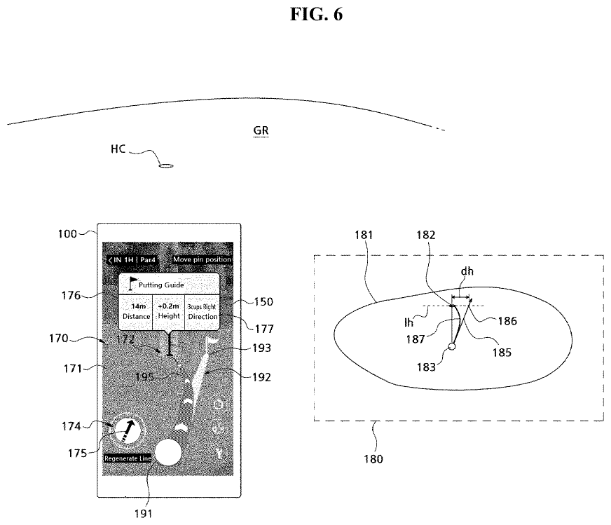

FIG. 4 shows a situation in which a position of a golf ball is specified on the green in the golf round of the user according to an embodiment of the present invention. FIG. 5 shows a process in which the user specifies a position of the golf ball through the putting interface of the user terminal in a state shown in FIG. 4 and putting information based on the position is displayed on the putting interface. FIG. 6 shows a state in which a putting guide is displayed through the putting interface of the user terminal in the state shown in FIG. 5.

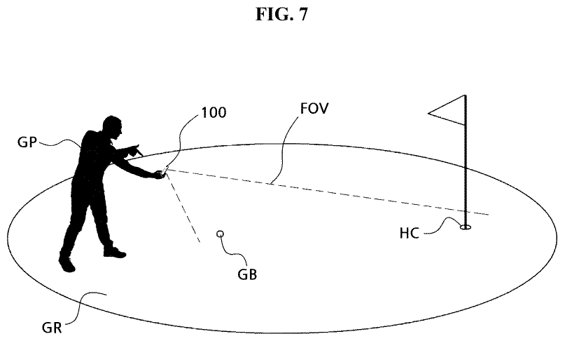

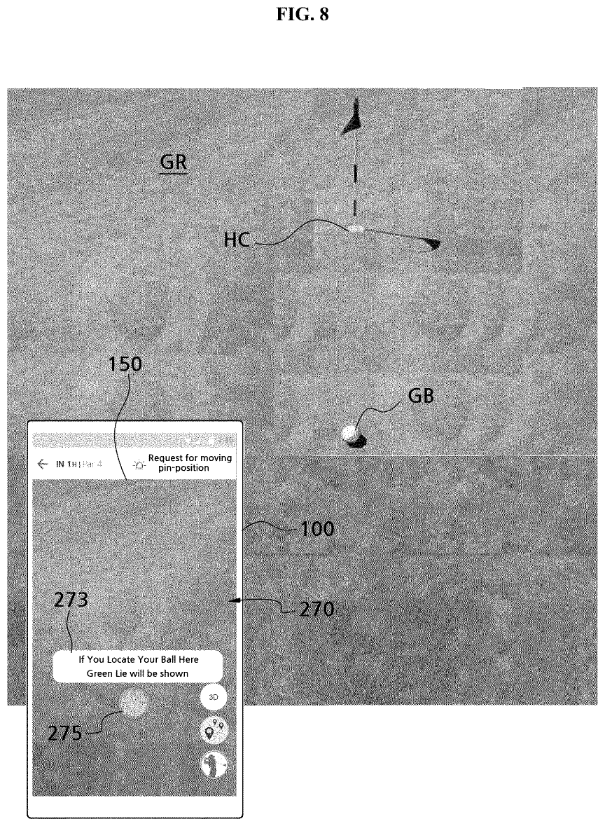

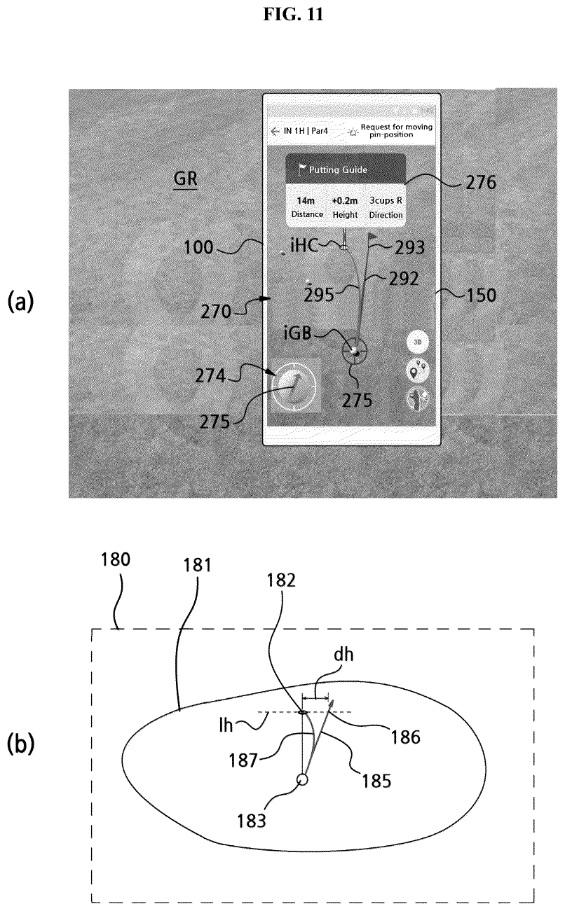

FIG. 7 shows another situation in which the position of the golf ball on the green is specified in the golf round of the user according to an embodiment of the present invention. FIGS. 8 to 10 show a process in which the user specifies a position of the golf ball through the putting interface of the user terminal in a state shown in FIG. 7. FIG. 11 shows a state in which the putting guide is displayed through the putting interface of the user terminal in the state shown in FIG. 7.

As shown in FIG. 4, when the golf ball GB is seated on the green GR during the golf round (i.e., on-green), as shown in FIG. 5, the putting interface 170 for providing putting information to the user GP is displayed on the display 150 of the user terminal 100, and the user GP may specify position information where the golf ball GB is placed on the green GR using the putting interface 170.

As shown in FIG. 5, the putting interface 170 may be configured to represent the hole-cup object 172 representing the hole cup and the ball position button 175 representing the golf ball on the background image 171 representing the green. The screen of the putting interface 170 may be displayed in the form of looking at the hole-cup object 172 from the ball position button 175 in the same view as looking at the hole cup from the position of the golf ball on the real green. The ball position button 175 on the putting interface may be configured to allow a user to input by a touch or a gesture. In addition, as shown in FIG. 5, the operation guide part 173 may be displayed so that the user may manipulate the putting interface 170.

For example, as shown in FIG. 4, the user GP is located adjacent to the position where the golf ball GB is placed on the green GR (e.g., standing close behind the golf ball GB), and as shown in FIG. 5, the user touches or performs to touch & gesture the ball position button 175 on the putting interface 170 of the user terminal 100, the GPS module in the user terminal 100 may extract the current position information of the user terminal 100 and transmit it to the server.

As shown in FIG. 4, the position of the user terminal (position detected by the GPS module) at a position adjacent to the golf ball GB may be quite close to or within a tolerance range with the position of the golf ball GB on the plane.

As shown in FIGS. 4 and 5, when the user touches the ball position button 175 on the putting interface 170 displayed on the user terminal 100, the terminal position received by the GPS module of the user terminal can be considered as the position of the golf ball GB. Accordingly, the terminal position received by the GPS module can be determined as the ball position on the virtual green.

In FIG. 5, reference number 180 indicates that the virtual green 181 is assumed so that the server or the user terminal may calculate putting information and putting guide information based on the green terrain information on the green GR.

The virtual green 181 is generated in a virtual space according to green terrain information on the real green in order for the server or the user terminal to provide putting information or the like through the putting interface.

The picture of the virtual area 180 including the virtual green 181 shown in FIG. 5 may be a diagram showing that the server or the user terminal does not actually implement the picture, but that the server or the user terminal obtains putting information and putting guide information based on the green terrain information through internal calculation and internal simulation.

Using the position coordinate information of the ball position 183 corresponding to the position of the golf ball and the cup position 182 corresponding to the position of the hole-cup on the virtual green 181 that is the same as the green terrain of the real green, the server or the user terminal may calculate the distance D between the ball position and the cup position and calculate information such as the slope of the real green based on the information of the green lie 184 between the ball position 183 and the cup position 182.

The calculated distance D and green lie 184 information between the ball position 183 and the cup position 182 can be displayed through the putting information window 176 on the putting interface 170 displayed on the display 150 of the user terminal 100, and the user who sees this can establish a putting strategy based on the information.

In addition, as shown in FIG. 6, the server or the user terminal may determine a putting direction 185 that allows a golf ball to reach the cup position according to the green lie between the ball position and the cup position when hitting the golf ball at the ball position. Wherein the server or the user terminal may determine the putting direction 185 starting from the ball position 183 through internal calculation and simulation based on the green lie between the ball position 183 and the cup position 182 on the virtual green 181, and calculate a putting aiming point 186 that is the point where a horizontal line Ih passing through the cup position 182 and a line of the putting direction 185 from the ball position 183 meet each other.

In addition, as shown in FIG. 6, the server or the user terminal can generate a putting line 187, which is a path of a golf ball simulated from the ball position 183, by the putting direction 185 from the ball position 183 on the virtual green 181 and the green lie between the ball position 183 and the cup position 182.

The putting direction, the putting aiming point, and the putting line generated as described above may be graphically generated and displayed on the putting interface 170 of the user terminal 100 as shown in FIG. 6.

That is, as shown in FIG. 6, a ball object 191 and a hole-cup object 172 may be displayed on the putting interface 170 of the user terminal 100, a putting direction line 192 progressing from the ball object 191 in response to the putting direction, an aiming reference portion 193 located at the end of the putting direction line 192 may be displayed in response to the putting aiming point 186, and a putting line reference portion 195 connected from the ball object 191 to the hole-cup object 172 may be displayed in response to the putting line 187.

In addition, information indicating a directional distance dh, which is the distance from the cup position 182 to the putting aiming point 186 in the virtual green 181, may be displayed in the putting information window 176 on the putting interface 170. The reference number 177 indicates the directional distance in the putting information window, which may be converted into the number of hole-cups instead of being expressed as a simple distance.

As described above, the put direction line 192, the aiming reference portion 193, and the putting line reference portion 195 in response to the putting direction 185, the putting aiming point 186, and the putting line 187 calculated on the virtual green based on the actual green terrain may be provided as the putting guide to the user through the putting interface 170 of the user terminal 100.

In addition, a ball display portion 174 with respect to a golf ball may be displayed on a portion of the putting interface 170 and a direction indicator 175 indicating the putting direction may be displayed on the ball display portion 174 in order to guide the user's putting more effectively.

Meanwhile, a method for providing putting information and putting guide information for the user will be described with reference to FIGS. 7 to 11.

As shown in FIG. 7, when the golf ball GB is seated on the green GR while the user GP plays a golf round in a golf course, as shown in FIG. 8, the putting interface 270 for providing putting information to the user is displayed on the display 150 of the user terminal 100, and the user may specify the position where the golf ball is placed on the green GR using the putting interface 270.

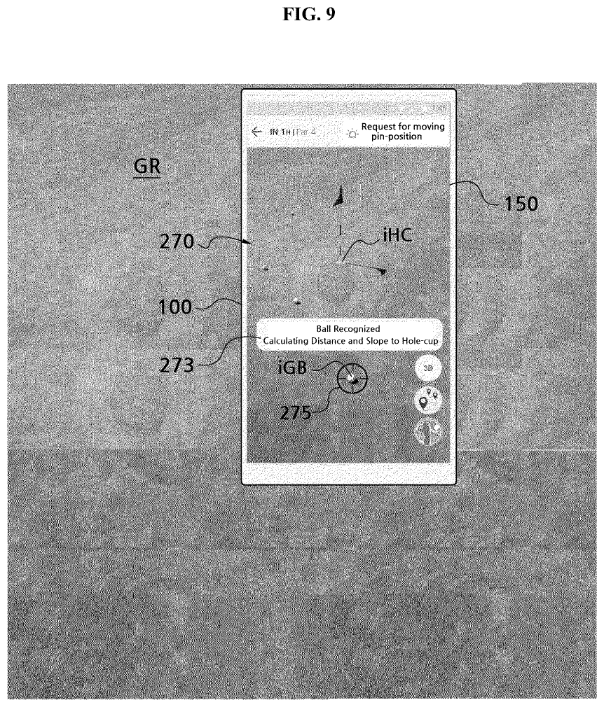

FIGS. 8 and 9 show a new type of putting interface. As shown in FIGS. 8 and 9, the putting interface 270 may display an image captured by the camera of the user terminal 100 and display the ball position alignment portion 275 to align the golf ball GB on the green GR at a predetermined position on the putting interface 270.

In addition, as shown in FIGS. 8 and 9, the putting interface 270 may display an action guide 273 that guides the user's actions or gestures so that the user can align the ball position using the putting interface 270.

As shown in FIG. 7, the user GP may use the putting interface behind the position where the golf ball GB is placed on the green GR, wherein the user may capture to include the golf ball GB and the hole-cup HC in the field of view (FOV) of the camera using the putting interface 270 on the user terminal 100 as shown in FIGS. 8 and 9.

In addition, as shown in FIGS. 8 and 9, the user may move the user terminal 100 to display the hole-cup image iHC capturing the hole-cup HC on the putting interface 270, while the ball image iGB capturing the golf ball GB on the green GR is located in the ball position alignment portion 275 on the putting interface 270 so that the position of the golf ball GB is aligned in the putting interface 270. Accordingly, the GPS module in the user terminal 100 may detect the current position information of the user terminal 100 and the detected position information may be transmitted to the server.

The server or the user terminal may calculate the position of the golf ball GB on the green GR by using the position of the hole cup HC according to the topographic information of the green GR, the position of the user terminal according to the GPS module, and information sensed by the sensor module in the user terminal.

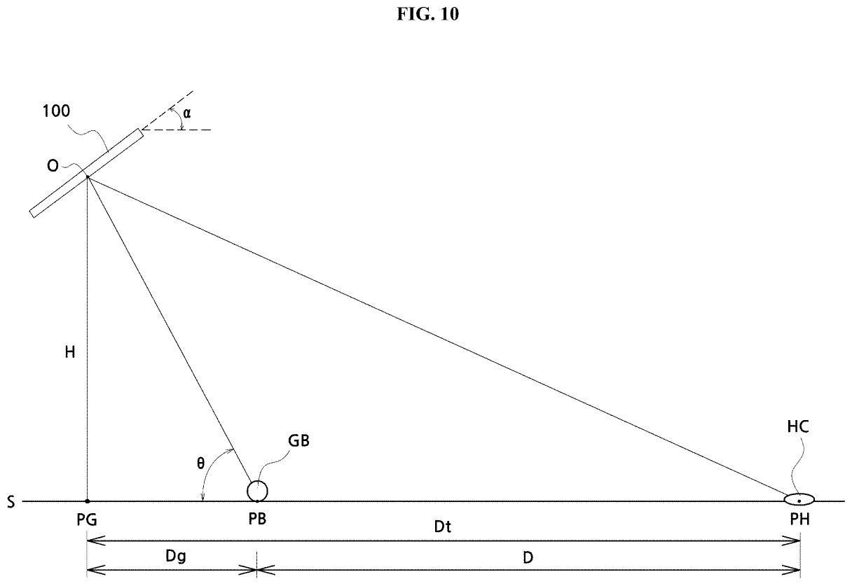

For example, as shown in FIG. 10, a position of the terminal PG may be calculated by the GPS module of the user terminal 100. And, when the hole-cup HC and the golf ball GB are captured on the screen image in the putting interface of the user terminal 100, and the golf ball GB is aligned with the ball position alignment portion 275, the sensor module inside the user terminal 100 may detect the inclined angle α of the terminal with respect to the reference plane S.

In addition, the height H of the user terminal 100 with respect to the reference plane S may be detected by the sensor module.

Since the golf ball GB is aligned with the ball position alignment portion 275, the angle θ formed by a line from the origin point O of the user terminal to the position of the golf ball GB with the reference surface S may be calculated by the inclined angle α of the terminal and geometric analysis.

Using the height H and the angle θ as described above, a distance Dg between the position of the terminal PG and the position of the golf ball PB may be calculated, and coordinates for the position of the golf ball PB may be calculated using the coordinates of the position of the terminal PG detected by the GPS module, the coordinates of the position of the hole-cup PH according to the green terrain information, and the above distance Dg.

In this way, the position (PG) coordinates of the terminal, the position (PB) coordinates of the golf ball, and the position (PH) coordinates of the hole-cup may be obtained, and thus the distance D between the golf ball GB and the hole-cup HC may also be obtained. In FIG. 10, Dt represents the total distance (the distance from the position of the terminal to the position of the hole-cup) obtained by summing the distance Dg and the distance D.

As described above, the position coordinates of the golf ball GB may be calculated by geometric calculation and position information of the terminal by the GPS module, and the calculated position coordinates of the golf ball may be determined as the ball position on the virtual green.

Reference number 180 in FIG. 11(b) indicates that a virtual green is assumed, which allows the server or the user terminal to calculate putting information, putting guide information, and the like based on the green terrain information on the green GR. The virtual green 181 is assumed virtually by the server or the user terminal according to the green terrain information on the real green in order to provide putting information or the like through the putting interface.

The picture of the virtual area 180 including the virtual green 181 shown in FIG. 11(b) may be a diagram showing that the server or the user terminal does not actually implement the picture, but that the server or the user terminal obtains putting information and putting guide information based on the green terrain information through internal calculation and internal simulation.

The server or the user terminal may calculate the slope of the real green based on information on the green lie 184 between the ball position 183 corresponding to the position of the golf ball and the cup position 182 corresponding to the position of the hole-cup on the virtual green 181 that is the same as the green terrain of the real green.

As shown in FIG. 11(a), the calculated distance and the green lie information between the ball position 183 and the cup position 182 can be displayed through the putting information window 276 on the putting interface 270 displayed on the display 150 of the user terminal 100, and the user who sees this can establish a putting strategy based on the information.

In addition, as shown in FIG. 11(b), the server or the user terminal may determine a putting direction 185 that allows a golf ball to reach the cup position according to the green lie between the ball position and the cup position when hitting the golf ball at the ball position. Wherein the server or the user terminal may determine the putting direction 185 starting from the ball position 183 through internal calculation and simulation based on the green lie between the ball position 183 and the cup position 182 on the virtual green 181, and calculate a putting aiming point 186 that is the point where a horizontal line lh passing through the cup position 182 and a line of the putting direction 185 from the ball position 183 meet each other.

In addition, as shown in FIG. 11(b), the server or the user terminal can generate a putting line 187, which is a path of a golf ball simulated from the ball position 183, by the putting direction 185 from the ball position 183 on the virtual green 181 and the green lie between the ball position 183 and the cup position 182.

The putting direction, the putting aiming point, and the putting line generated as described above may be graphically generated and displayed on the putting interface 270 of the user terminal 100 as shown in FIG. 11(a).

That is, as shown in FIG. 11(a), the putting interface 270 may display: the putting direction line 292 progressing from the ball image iGB captured in the ball position alignment portion 275 on the putting interface 270 of the user terminal 100 corresponding to the above putting direction; the aiming reference portion 293 provided at the end of the putting direction line 292 corresponding to the putting aiming point 186 described above; and the putting line reference portion 295 connected from the ball image iGB to the hole-cup image iHC corresponding to the putting line 187 described above.

In addition, information indicating a directional distance dh, which is the distance from the cup position 182 to the putting aiming point 186 in the virtual green 181, may be displayed in the putting information window 276 on the putting interface 270.

As described above, the put direction line 292, the aiming reference portion 293, and the putting line reference portion 295 in response to the putting direction 185, the putting aiming point 186, and the putting line 187 calculated on the virtual green based on the actual green terrain may be provided as the putting guide to the user through the putting interface 270 of the user terminal 100.

In addition, a ball display portion 274 with respect to a golf ball may be displayed on a portion of the putting interface 270 and a direction indicator 275 indicating the putting direction may be displayed on the ball display portion 274 in order to guide the user's putting more effectively.

As described above, the system for providing putting information, method for providing putting information, method for controlling user terminal for guiding user's putting play and recording media recording the method readable by computing device according to the present invention have an advantageous effect that when a user accesses a server with a user terminal possessed by the user who plays golf on a golf course and putts on a green of the golf course, the user can receive information on the green being putted and an accurate putting guide based on topography of the green between a golf ball and a hole-cup on the green from the server through the user terminal using information obtained using a putting interface displayed on the user terminal so that the user who putts on the green to easily perform putting play without help of a caddy or the like.

### INDUSTRIAL APPLICABILITY

A system for providing putting information, method for providing putting information, method for controlling user terminal for guiding user's putting play and recording media recording the method readable by computing device according to the present invention can be used in the field of golf sports or virtual golf simulation systems such as so-called screen golf and hybrid golf.

1. A method for providing putting information to a user who play golf on a golf course to guide putting play through a user terminal by a server, the method comprising:
transmitting green terrain information about a real green where the user plays putting to the user terminal connected to the server;
determining a ball position on a virtual green which is generated based on the green terrain information corresponding to a position of a golf ball on the real green, and generating putting information including a distance between the golf ball and a hole-cup on the real green and a green lie using the determined ball position and a cup position on the virtual green corresponding to a position of the hole-cup on the real green by the user's manipulation through a putting interface of the user terminal for processing to generate the putting information; and
generating putting guide information including at least one of a putting expected path and a putting direction from the ball position to the cup position on the virtual green using the generated putting information so that the putting guide information is provided through the putting interface.

2. The method according to claim 1, wherein the generating putting information includes:
receiving a position of the user terminal by a GPS module of the user terminal as the user manipulates through the putting interface at a location adjacent to the golf ball placed on the real green;
determining the received position of the user terminal as the ball position on the virtual green; and
generating information on the distance and slope from the ball position to the cup position as the putting information.

3. The method according to claim 1, wherein the putting interface is configured to capture and display the golf ball and the hole-cup on the real green by a camera of the user terminal, and to display a ball position alignment portion so that the captured golf ball can be aligned at a predetermined position on the putting interface, and
wherein the generating putting information includes:
determining the ball position on the virtual green using a position of the user terminal by a GPS module of the user terminal, a cup position on the virtual green, and a positional relationship between the golf ball and the hole-cup aligned through the putting interface as the user aligns the golf ball with the hole-cup on the putting interface; and
generating information on the distance and slope from the ball position to the cup position as the putting information.

4. The method according to claim 1, wherein the generating putting guide information so that the putting guide information is provided through the putting interface includes:
determining a putting direction starting from the ball position based on the green lie between the ball position and the cup position on the virtual green; and
determining a path from the ball position to the cup position formed by the green lie if the golf ball is putted from the ball position to the putting direction as a putting expected path.

5. The method according to claim 4, further comprising:
determining a putting aiming point in the determined putting direction; and
determining a directional distance, which is a distance from the cup position to the putting aiming point.

6. (canceled)

7. A method for controlling a user terminal for guiding a user who play golf on a golf course to putt on a real green, the method comprising:
downloading green terrain information about the real green from a server connected to the user terminal;
displaying a putting interface for generating putting information including a distance between a golf ball and a hole-cup on the real green and a green lie;
when a ball position on a virtual green which is generated based on the green terrain information corresponding to a position of a golf ball on the real green by the user's manipulation through a putting interface of the user terminal is determined, displaying putting information generated using the determined ball position and a cup position on the virtual green corresponding to a position of the hole-cup on the real green; and
displaying on the putting interface, putting guide information including at least one of a putting expected path and a putting direction from the ball position to the cup position on the virtual green determined using the generated putting information.

8. The method according to claim 7, wherein the displaying putting information includes:
detecting the user's manipulation through the putting interface and determining a position of the user terminal by a GPS module of the user terminal as the ball position on the virtual green; and
displaying the determined result of the distance and slope from the determined ball position to the cup position on the putting interface.

9. The method according to claim 7, wherein the putting interface is configured to capture and display the golf ball and the hole-cup on the real green by a camera of the user terminal, and to display a ball position alignment portion so that the captured golf ball can be aligned at a predetermined position on the putting interface, and
wherein the displaying putting guide information includes:
determining the ball position on the virtual green using a position of the user terminal by a GPS module of the user terminal, a cup position on the virtual green, and a positional relationship between the golf ball and the hole-cup aligned through the putting interface as the user aligns the golf ball with the hole-cup on the putting interface; and
displaying on the putting interface, the distance and slope from the ball position to the cup position.

10. The method according to claim 7, wherein the displaying putting guide information includes:
when a putting direction starting from the ball position based on the green lie between the ball position and the cup position on the virtual green is determined, displaying a line of the putting direction, which is a straight line from the ball position to a putting aiming point in the putting direction, on the putting interface as the putting guide.

11. The method according to claim 7, wherein the displaying putting guide information includes:
when a putting direction starting from the ball position based on the green lie between the ball position and the cup position on the virtual green is determined, displaying a putting line of a path from the ball position to the cup position formed by the green lie if the golf ball is putted from the ball position to the putting direction, on the putting interface as the putting guide.

12. The method according to claim 7, wherein the displaying putting guide information further includes:
when a putting direction starting from the ball position based on the green lie between the ball position and the cup position on the virtual green is determined, and a putting aiming point on the putting direction from the ball position is determined, displaying a directional distance, which is a distance from the cup position to the putting aiming point, on the putting interface.

13. (canceled)

14. A system for providing putting information to a user who play golf on a golf course to guide putting play through a user terminal, the system comprising:
a database that stores green terrain information about a green of each hole in the golf course; and
a server that communicates with the user terminal through network connection, wherein the server extracts green terrain information about the green of the hole in which the user is playing from the database and transmits the extracted information to the user terminal, and wherein the server generates putting information for guiding the user's putting play based on a virtual green generated by the extracted green terrain information and provides the generated information to the user through the user terminal,
wherein the server is configured to process:
determining a ball position on a virtual green which is generated based on the green terrain information corresponding to a position of a golf ball on the green on which the user is playing by the user's manipulation through a putting interface of the user terminal for processing to generate the putting information including a distance between the golf ball and a hole-cup on the real green and a green lie,
generating the putting information using the determined ball position and a cup position on the virtual green corresponding to a position of a hole-cup on the green, and
generating putting guide information including at least one of a putting expected path and a putting direction from the ball position to the cup position on the virtual green using the generated putting information so that the putting guide information is provided through the putting interface.
